(19) United States
(12) Patent Application Publication
(10) Pub. No.: US 2008/0060385 A1
(43) Pub. Date: Mar. 13, 2008

(54) WHEEL AND ROLL ASSEMBLY FOR HOT GLASS SHEET CONVEYANCE

(75) Inventors: Alfredo Serrano, Maumee, OH (US); Thomas J. Zalesak, Rossford, OH (US)

Correspondence Address: BROOKS KUSHMAN P.C., 1000 TOWN CENTER, TWENTY-SECOND FLOOR, SOUTHFIELD, MI, 48075, US

(73) Assignee: GLASSTECH, INC., Perrysburg, OH (US)

(21) Appl. No.: 11/530,955

(22) Filed: Sep. 12, 2006

(51) Int. Cl. C03B 13/00

(52) U.S. Cl. 65/253

(57) ABSTRACT

A hot glass sheet roll assembly wheel (60) and resultant roll assembly utilizing such wheels includes an annular tire (64) having a central axis A, a synthetic resin rim (70) molded in situ within the tire, and a central formation (70) for supporting the wheel about the central axis A.

### BACKGROUND OF THE INVENTION

1. Field of the Invention

This invention relates to a wheel for hot glass sheet conveyance and to a roll assembly that incorporates a plurality of the wheels for providing the hot glass sheet conveyance.

2. Background Art

U.S. Pat. No. 6,378,339 discloses a glass sheet forming system including roll assemblies that provide glass sheet forming and conveyance during the forming. The conveyance as disclosed is between a lower roll conveyor and an upper roll former which receive a hot glass sheet in a flat shape and are then curved to provide the glass sheet forming. Both the lower roll conveyor and the upper roll former include hot glass sheet roll assemblies which include wheels whose outer peripheries contact the glass sheet from below and above. These wheels have previously included a center rim and an outer glass contacting portion that is made of a temperature resistant rope that is wrapped around the wheel and has ends secured within a radial opening in the rim to provide securement. Thus, the outer surface of such wheels does not have a 360° continuous surface for contacting the glass sheet being conveyed.

### SUMMARY OF THE INVENTION

An object of the present invention is to provide an improved wheel for a hot glass sheet roll assembly for providing hot glass sheet conveyance.

In carrying out the above object, the wheel includes an annular tire that is made of high temperature resistant synthetic resin and has a central axis. The annular tire has a round outer surface for contacting a hot glass sheet for conveyance and has a round inner surface defining an interior through which the central axis extends. The wheel also includes a synthetic resin rim molded in situ within the interior of the tire in supporting contact with its inner surface, and the rim has a central formation that rotatably supports the wheel for rotation about the central axis.

As disclosed, the annular tire includes a woven material embedded within the high temperature resistant synthetic resin. Furthermore, the resin of the annular tire is made from one or more aramids. Also, the synthetic resin rim is molded in situ within the interior of the tire from a high temperature resistant thermosetting resin. In addition, the round outer surface of the tire has a round cylindrical shape extending parallel to the central axis.

In two disclosed embodiments of the wheel, the central formation of the rim for supporting the wheel comprises an opening through the rim. In one embodiment, the opening through the rim is round when rotational driving is not necessary. In another embodiment, the opening through the rim has any rotational driving shape, a somewhat square shape with rounded corners as disclosed.

The round outer surface of the tire preferably has a round cylindrical shape extending parallel to the central axis, and the rim has opposite axial ends including associated radial outer annular portions. Also, the tire has opposite axial ends between which its round outer surface extends parallel to the central axis with the round cylindrical shape, and the radial outer annular portions of the rim are located closer to each other than the opposite axial ends of the tire. Each axial end of the tire extends away from its other axial end past the radial outer annular portion of the adjacent axial end of the rim in a cantilevered manner. The radial outer annular portions of the opposite axial ends of the rim as disclosed are round axial grooves that extend axially toward each other. As illustrated, these axial grooves having horizontal V shapes that point toward each other.

Another object of the invention is to provide an improved hot glass sheet roll assembly for providing hot glass sheet conveyance.

In carrying out the immediately preceding object, the hot glass sheet roll assembly for providing hot glass sheet conveyance includes an elongated shaft having a central axis. The roll assembly also includes a plurality of wheels spaced along the shaft. Each wheel includes an annular tire of high temperature resistant synthetic resin and having a central axis that is the same as the central axis of the shaft. The annular tire has a round outer surface for contacting a hot glass sheet for conveyance, and the annular tire has a round inner surface defining an interior through which the central axis extends. The roll assembly also includes a synthetic resin rim molded in situ within the interior of the tire in supporting contact with its inner surface, and the rim has a central opening that receives the shaft and supports the wheel for rotation about the central axis.

The objects, features and advantages of the present invention are readily apparent from the following detailed description of the preferred embodiments when taken in connection with the accompanying drawings.

### BRIEF DESCRIPTION OF THE DRAWINGS

FIG. 1 is a schematic side elevational view of a glass sheet forming system whose components embody the present invention.

FIG. 2 is a sectional view taken along the direction of line 2-2 in FIG. 1 to illustrate a glass sheet forming station which includes lower and upper hot glass sheet roll assemblies that embody the present invention and include wheels constructed in accordance with the invention.

FIG. 3 is a view similar to FIG. 2 but shown after the lower and upper roll assemblies have been moved from a straight shape to a curved shape to provide glass sheet forming.

FIG. 4 is a view of another embodiment similar to the one of FIGS. 2 and 3 but having upper wheels that are individually supported without being supported by a common shaft like the wheels of the lower roll assembly.

FIG. 5 is a longitudinal sectional view taken through one of the hot glass sheet roll assemblies to illustrate its construction and the construction of the wheel of the invention.

FIG. 6 is an enlarged view illustrating the construction of the outer periphery of a wheel rim and an outer tire that extends around the rim.

FIG. 7 is an end view taken along the direction of line 7-7 in FIG. 5 to illustrate the construction of the wheel when it is designed to provide rotational driving.

FIG. 8 is a partial view similar to FIG. 7 of another construction when the wheel is not designed to be rotatively driven but rather is freewheeling.

FIG. 9 is a schematic view illustrating a mold in which the wheel rim is molded in situ within the tire to provide the wheel manufacturing.

### DETAILED DESCRIPTION OF THE PREFERRED EMBODIMENTS

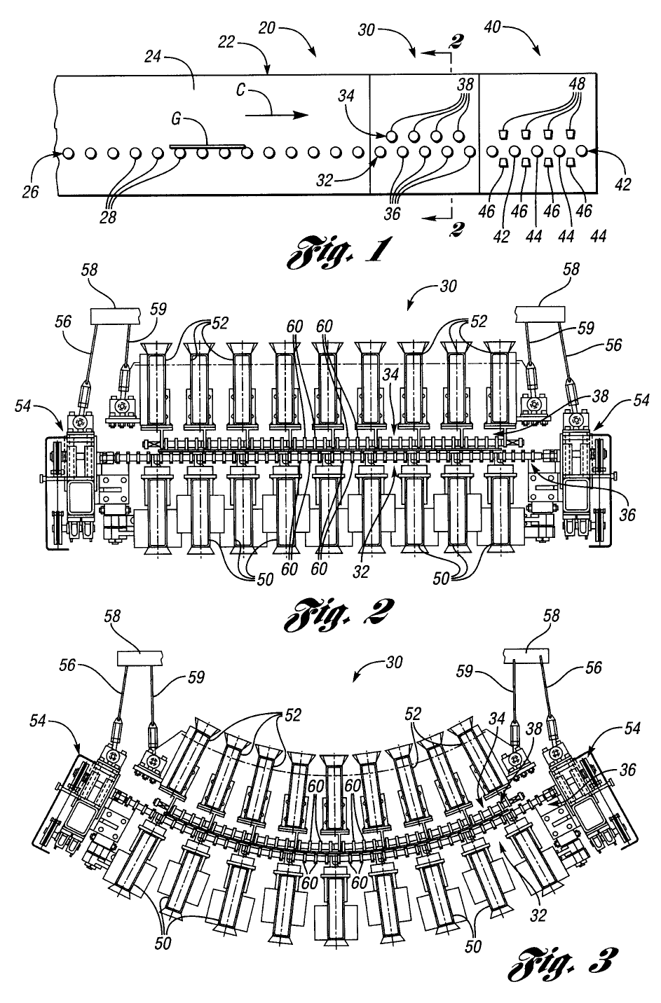

With reference to FIG. 1, a glass sheet forming system is generally indicated by 20 and includes a furnace 22 having a heating chamber 24 and a conveyor 26 that is located within the heating chamber to convey glass sheets G along a direction of conveyance shown by arrow C. As illustrated, the conveyor 26 includes rolls 28 that convey the glass sheets G through the heating chamber 24 for heating to a forming temperature. A forming station 30 of the system 20 is located downstream from the furnace 22 to receive the heated glass sheets for forming. More specifically, a lower roll conveyor 32 and an upper roll former 34 include hot glass sheet roll assemblies 36 and 38 respectively, which are constructed in accordance with the invention as is hereinafter more fully described. Glass sheet forming system 20 also includes a cooling station 40 having a conveyor 42 with rolls 44 for receiving the formed glass sheets. Lower and upper quench heads 46 and 48 of the cooling station respectively provide upwardly and downwardly directed quenching air to rapidly cool the formed glass sheets in order to improve their mechanical properties.

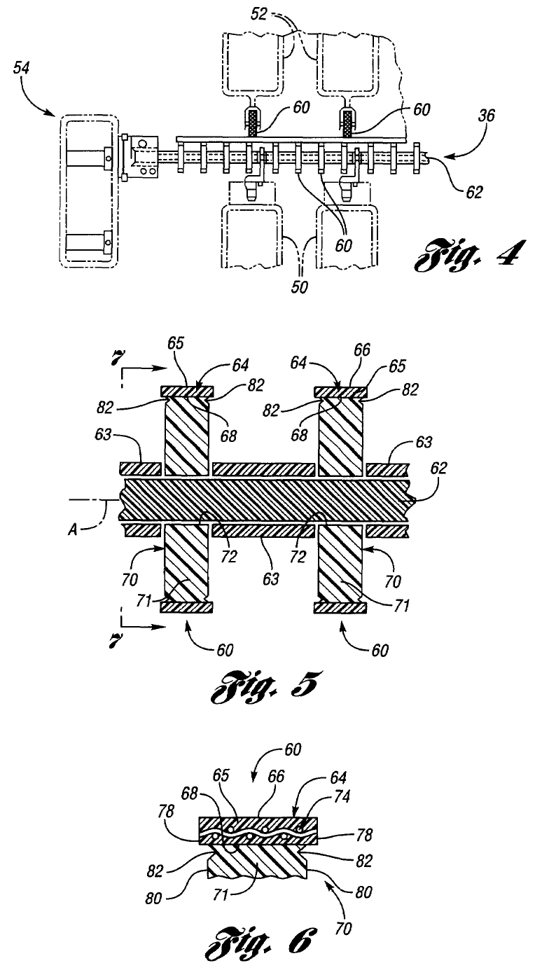

As illustrated in FIG. 2, the forming station 30 has its lower and upper hot glass sheet roll assemblies 36 and 38 supported by lower and upper elongated members 50 and 52, respectively, that extend along the direction of conveyance. The lower hot glass sheet roll assemblies 36 are rotatively driven by drive mechanisms 54 at the lateral sides of the system and are supported by suspension members 56 on a framework 58. The upper hot glass sheet roll assemblies 38, which are freewheeling and thus not rotatively driven, are mounted by the upper elongated members 52 which are supported at the opposite lateral sides of the system by suspension members 59 on the framework 58. The opposite upstream and downstream ends of the lower and upper elongated members 50 and 52 are supported by linkages in accordance with the teachings of U.S. Pat. Nos. 5,498,275; 5,556,444; 5,697,999; and 6,378,339, the entire disclosures of which are hereby incorporated by reference. Suspension members 56 and 59 are operated to move the hot glass sheet roll assemblies 36 and 38 from their flat shape of FIG. 2 to their curved shape of FIG. 3 in order to provide the glass sheet forming. Both the lower and upper hot glass sheet roll assemblies 36 and 38 shown in FIGS. 2 and 3 have wheels 60 that are constructed in accordance with the invention and are mounted by associated shafts 62 as illustrated in FIG. 5, and the wheels are spaced form each other by spacers 63 through which the shaft also extends. In the embodiment of FIG. 4, the lower hot glass sheet roll assemblies 36 also have wheels connected by shafts 62, but the upper wheels 60 are individually mounted on the associated upper elongated members 52.

With reference to FIGS. 5-8, each hot glass sheet roll assembly wheel 60 includes an annular tire 64 of a high temperature resistant synthetic resin 65 and has a central axis A that is also the same as the central axis A of shaft 62. The annular tire 64 has a round outer surface 66 for contacting glass sheets for conveyance, and the tire also has a round inner surface 68 defining an interior through which the central axis A extends. Each wheel 60 also includes a rim 70 of a synthetic resin 71 that is molded in situ within the interior of the tire 64 in supporting contact with the tire inner surface 68. The rim 70 has a central formation 72 that rotatively supports the wheel for rotation about the central axis A as described below.

The annular tire 64 of each wheel 60 as shown in FIG. 6 includes a woven material 74 embedded within the high temperature resistant synthetic resin 65 of the tire, and this synthetic resin forming the tire is preferably made with one or more aramids. Furthermore, the synthetic resin rim 70 is molded in situ within a mold 76 shown in FIG. 9 and is made from a high temperature resistant thermosetting resin.

As illustrated in FIGS. 5-7, the round outer surface 66 of each wheel tire 64 has a round cylindrical shape extending parallel to the central axis A. The tire 64 has opposite axial ends 78 between which its round outer surface 66 extends parallel to the central axis A with the round cylindrical shape. Furthermore, the rim 70 has opposite axial ends 80 which, as best illustrated in FIG. 6, have radial outer annular portions 82 which immediately adjacent the tire inner surface 68 are located axially closer to each other than the opposite axial ends 78 of the tire, such that each axial end 78 of the tire 64 extends from its other axial end past the radial outer annular portion 82 of the adjacent axial end 80 of the rim 70 in a cantilevered manner. This construction insures that the round outer surface 66 of the tire contacts the glass sheet along the entire width during the conveyance. Radial outer annular portions 82 of the rim as disclosed are embodied as axial grooves that extend axially toward each other and, as shown, have horizontal V shapes that point toward each other.

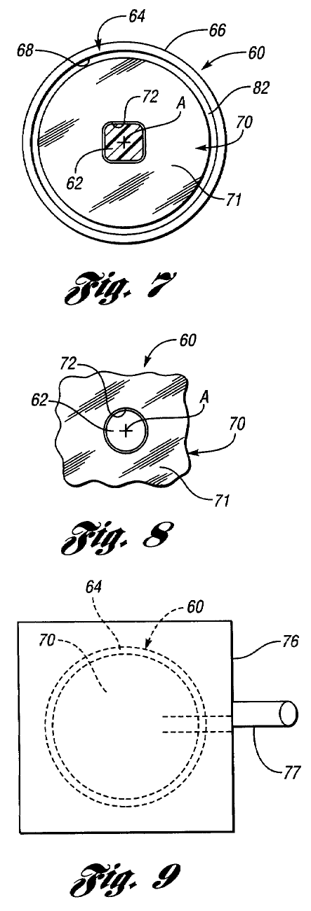

The wheels 60 utilized to provide rotational driving of the lower roll assemblies 36 have central formations 72 provided by openings which may have any rotational driving shape such as the somewhat square shape with rounded corners like their associated shaft 62 as illustrated in FIG. 7. Wheels that are freewheeling such as the wheels 60 utilized with the upper roll assemblies 38 may have round shapes like their associated shaft 62 such as illustrated in FIG. 8.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A wheel for a hot glass sheet roll assembly for providing hot glass sheet conveyance, the wheel comprising:
an annular tire of high temperature resistant synthetic resin and having a central axis, the annular tire having a round outer surface for contacting a hot glass sheet for conveyance, and the annular tire having a round inner surface defining an interior through which the central axis extends; and
a synthetic resin rim molded in situ within the interior of the tire in supporting contact with its inner surface, and the rim having a central formation that rotatably supports the wheel for rotation about the central axis.

2. A hot glass sheet roll assembly wheel as in claim 1 wherein the annular tire includes a woven material embedded within the high temperature resistant synthetic resin of the tire.

3. A hot glass sheet roll assembly wheel as in claim 2 wherein the annular tire is made from one or more aramids.

4. A hot glass sheet roll assembly wheel as in claim 2 wherein the synthetic resin rim is molded in situ within the interior of the tire from a high temperature resistant thermosetting resin.

5. A hot glass sheet roll assembly wheel as in claim 1 wherein the annular tire is made from at least one aramid and wherein the synthetic resin rim is molded in situ within the interior of the tire from a thermosetting resin.

6. A hot glass sheet roll assembly wheel as in claim 1 wherein the round outer surface of the tire has a round cylindrical shape extending parallel to the central axis.

7. A hot glass sheet roll assembly wheel as in claim 1 wherein the central formation for supporting the wheel comprises an opening through the rim.

8. A hot glass sheet roll assembly wheel as in claim 7 wherein the opening through the rim is selected from the group consisting of a round opening and an opening having any rotational driving shape.

9. A hot glass sheet roll assembly wheel as in claim 8 wherein the opening through the rim is somewhat square with rounded corners to provide rotational driving.

10. A hot glass sheet roll assembly wheel as in claim 1 wherein the round outer surface of the tire has a round cylindrical shape extending parallel to the central axis, and the rim having opposite axial ends including associated radial outer annular portions that immediately adjacent the tire inner surface are located axially closer to each other than the opposite axial ends of the tire with each axial end of the tire extending away from its other axial end past the adjacent radial outer annular portion of the rim in a cantilevered manner.

11. A hot glass sheet roll assembly wheel as in claim 10 wherein the outer annular formations of the opposite axial ends of the rim comprise round axial grooves that extend axially toward each other.

12. A hot glass sheet roll assembly as in claim 11 wherein the round axial grooves of the rim have horizontal V shapes that point toward each other.

13. A wheel for a hot glass sheet roll assembly for providing hot glass sheet conveyance, the wheel comprising:
an annular tire of high temperature resistant synthetic resin of at least one aramid and having a central axis, the annular tire having a round outer surface for contacting a hot glass sheet for conveyance, the round outer surface having a round cylindrical shape extending parallel to the central axis, the annular tire having a round inner surface defining an interior through which the central axis extends, and the annular tire having opposite axial ends; and
a synthetic thermoplastic resin rim molded in situ within the interior of the tire in supporting contact with its inner surface, the rim having a central opening that rotatably supports the wheel for rotation about the central axis, the rim having opposite axial ends including radial outer annular portions that are located closer to each other than the opposite axial ends of the tire, and each axial end of the tire extending away from its other axial end past the adjacent radial outer annular portion of the rim in a cantilevered manner.

14. A hot glass sheet roll assembly for providing hot glass sheet conveyance, the roll assembly comprising:
an elongated shaft having a central axis; and
a plurality of wheels spaced along the shaft, and each wheel including:
an annular tire of high temperature resistant synthetic resin and having a central axis that is the same as the central axis of the shaft, the annular tire having a round outer surface for contacting a hot glass sheet for conveyance, and the annular tire having a round inner surface defining an interior through which the central axis extends; and
a synthetic resin rim molded in situ within the interior of the tire in supporting contact with its inner surface, and the rim having a central opening that receives the shaft and supports the wheel for rotation about the central axis.
